(19) United States
(12) Patent Application Publication
(10) Pub. No.: US 2025/0233676 A1
(43) Pub. Date: Jul. 17, 2025

(54) OPTIMIZING FREQUENCY SPECTRUM ASSIGNMENT BASED ON HIGH-FIDELITY OBSTRUCTION HEIGHTS

(71) Applicant: Charter Communications Operating, LLC, St. Louis, MO (US)

(72) Inventors: Abdulrauf Hafeez, Cary, NC (US); Saúl A. Torrico, Bethesda, MD (US)

(21) Appl. No.: 18/415,214

(22) Filed: Jan. 17, 2024

(51) Int. Cl. H04B 17/345; H04B 17/20; H04W 16/14

(52) U.S. Cl. CPC H04B 17/345; H04B 17/253; H04W 16/14

(57) ABSTRACT

Topographic information and clutter information is obtained for a particular geographic area in which two or more wireless network's radio communication entities are located. The topographic information includes terrain height values for points within a particular geographic area. The clutter information includes clutter height values for at least some of the points indicative of a height of clutter located atop terrain within the particular geographic area. A plurality of high-fidelity obstruction height values are determined for sampled points. Each of the sampled points are located between a first network entity and a second network entity. Critical points are identified from the sampled points based on the plurality of high-fidelity obstruction height values. Propagation information indicative of a predicted degree of interference between the two network's entities is generated based on the one or more critical points.

### BACKGROUND

Some wireless networks, or particular regions of wireless spectrum, have introduced tiered access frameworks in which some entities have higher access priority than others. For example, the Citizens Broadband Radio Service (CBRS) refers to a shared region of wireless spectrum that allows different entities to utilize the same frequency bands dynamically. The Federal Communications Commission (FCC), which manages aspects of the CBRS, has introduced multiple tiers of access for the CBRS (e.g., incumbent entities, Priority Access License (PAL) holding entities, etc.). Management of access to such wireless networks is often handled by a managing entity, such as a Spectrum Access System (SAS). To follow the previous example, the SAS may sense CBRS spectrum access from the incumbent entity through an associated sensing network, and in response, identify and revoke access grants from the non-incumbent entities likely to cause interference.

Some tiered access networks are capable of assigning multiple network entities to the same region of frequency spectrum based on a predicted degree of interference. For example, if a SAS receives spectrum access requests for the same frequency band from two network entities located in the same area, the SAS may accept or reject the requests based on a predicted degree of interference for each of the entities. This degree of interference can be predicted based on path loss, which in turn can be predicted at least partially based on the height of terrain located between the network entities and a receiving base station. Accordingly, terrain information (e.g., information describing local terrain heights) can be utilized to make spectrum access decisions by SASs.

### SUMMARY

Topographic information (e.g., information describing terrain height values, etc.) can be obtained alongside clutter information (e.g., height information for clutter (e.g., buildings, vegetation, etc.) located atop the terrain, etc.) for a particular geographic area that includes multiple network entities (e.g., user devices, endpoint devices, base stations, etc.). High-fidelity obstruction height values can be determined for a sampling of points that are located between two network entities within the geographic area. Critical point(s) can be identified based on the high-fidelity obstruction height values, and propagation information can be generated based on the critical point(s). The propagation information can indicate a predicted degree of interference for one of the network entities.

In one implementation, a method is provided. The method includes obtaining, for a particular geographic area in which two or more network entities are located, (a) topographic information comprising terrain height values for a plurality of points within the particular geographic area, and (b) clutter information comprising clutter height values for at least some of the plurality of points, wherein a clutter height value is indicative of a height of clutter located atop terrain within the particular geographic area. The method includes determining, by the computing system, a plurality of high-fidelity obstruction height values for a plurality of sampled points from the plurality of points, wherein each of the plurality of sampled points are located between a first network entity and a second network entity of the two or more network entities. The method includes identifying, by the computing system, one or more critical points from the plurality of sampled points based on the plurality of high-fidelity obstruction height values. The method includes, based on the one or more critical points, generating, by the computing system, propagation information indicative of a predicted degree of interference for the first network entity.

In another implementation, a computing system is provided. The computing system includes a memory, and one or more processor devices coupled to the memory. The processor device(s) are configured to obtain, for a particular geographic area in which two or more network entities are located, (a) topographic information comprising terrain height values for a plurality of points within the particular geographic area, and (b) clutter information comprising clutter height values for at least some of the plurality of points, wherein a clutter height value is indicative of a height of clutter located atop terrain within the particular geographic area. The processor device(s) are configured to determine a plurality of high-fidelity obstruction height values for a plurality of sampled points from the plurality of points, wherein each of the plurality of sampled points are located between a first network entity and a second network entity of the two or more network entities. The processor device(s) are configured to identify one or more critical points from the plurality of sampled points based on the plurality of high-fidelity obstruction height values. The processor device(s) are configured to, based on the one or more critical points, generate propagation information indicative of a predicted degree of interference for the first network entity.

In another implementation, a non-transitory computer-readable storage medium is provided. The non-transitory computer-readable storage medium includes executable instructions to cause one or more processor devices to obtain, for a particular geographic area in which two or more network entities are located, (a) topographic information comprising terrain height values for a plurality of points within the particular geographic area, and (b) clutter information comprising clutter height values for at least some of the plurality of points, wherein a clutter height value is indicative of a height of clutter located atop terrain within the particular geographic area. The instructions further cause the processor device(s) to determine a plurality of high-fidelity obstruction height values for a plurality of sampled points from the plurality of points, wherein each of the plurality of sampled points are located between a first network entity and a second network entity of the two or more network entities. The instructions further cause the processor device(s) to identify one or more critical points from the plurality of sampled points based on the plurality of high-fidelity obstruction height values. The instructions further cause the processor device(s) to, based on the one or more critical points, generate propagation information indicative of a predicted degree of interference for the first network entity.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing optimization of frequency spectrum assignment based on high-fidelity obstruction heights according to some implementations of the present disclosure.

FIG. 2 depicts an example geographic area including network entities for which high-fidelity obstruction height values are synthesized for optimizing frequency spectrum assignment according to some implementations of the present disclosure.

FIG. 3 depicts a flow chart diagram of an example method to perform optimization of frequency spectrum assignment based on high-fidelity obstruction heights according to some implementations of the present disclosure.

FIG. 4 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

As described previously, some wireless networks, or particular regions of wireless spectrum, have introduced tiered access frameworks in which some entities have higher access priority than others. For example, the Citizens Broadband Radio Service (CBRS) refers to a shared region of wireless spectrum that allows different entities to utilize the same frequency bands dynamically. The Federal Communications Commission (FCC), which manages aspects of the CBRS, has introduced multiple tiers of access for the CBRS (e.g., incumbent entities, Priority Access License (PAL) holding entities, etc.). Management of access to such wireless networks is often handled by a managing entity, such as a Spectrum Access System (SAS). To follow the previous example, the SAS may receive the CBRS access request from the incumbent entity, and in response, identify and revoke access grants from the non-incumbent entities likely to cause interference.

Some tiered access networks are capable of assigning multiple network entities to the same part of frequency band (i.e. co-channel or adjacent channel) based on a predicted degree of interference. The predicted degree of interference can be determined by a SAS based on terrain information, which generally includes accurate measurements of terrain height within specific geographic areas. For example, if a SAS receives spectrum access requests for the same frequency band from two network entities located in the same area, the SAS may accept or reject the requests based on a predicted degree of interference for each of the entities. This degree of interference can be predicted based on path loss. Path loss, in turn, can be predicted at least partially based on the height of terrain located between the network entities and a receiving base station. In this manner, the SAS can utilize terrain height information to determine whether to grant spectrum access to a requesting entity.

More specifically, a SAS can determine a predicted degree of interference for a device requesting or requiring spectrum access based on the height of terrain existing between two entities (e.g., a Navy ship radar) and a network base station. If there is relatively high terrain with sufficient blocking to avoid interference between the requesting and receiving entities (e.g., obstructing a line of sight between the entities), the predicted degree of interference is likely to be low. In addition to spectrum access decisions, terrain information (e.g., information describing local terrain heights) can be utilized to make a number of organizational and architectural network planning decisions.

However, conventional terrain information usually fails to account for “clutter” that is located atop the terrain. Clutter can reduce wireless interference via “blocking,” which refers to physically obstructing wireless signals before one can interfere with the other. As described herein, “clutter” refers to any object (e.g., vegetation, billboard, infrastructure, etc.), building, man-made entity, etc. located atop the terrain of a geographic area. In some instances, the differences between terrain height and the combination of terrain and existing clutter height can be substantial. For example, while the terrain of New York City in some locations is only 2-3 meters above sea level, clutter located atop the terrain of New York City can be over 400 meters in height (e.g., the One World Trade Center, the Empire State Building, etc.).

To summarize, predicted interference can be determined based on terrain information which does not include clutter heights, and clutter can cause substantial blockage. As such, decisions made using predicted interference determined based on terrain information are necessarily inaccurate. To mitigate these inaccuracies, some decision making entities (e.g., network service providers) conservatively assume low or no clutter exists in particular geographic regions due to the actual degree of clutter being unknown.

To follow the previous example, assume that two network entities are located in a New York City suburb with relatively high clutter (e.g., tall buildings), and that both entities submit spectrum access requests to a SAS. With accurate clutter information, the SAS may predict a degree of interference sufficiently low as to grant both requests. However, without accurate clutter information, the SAS may predict a degree of interference based on clutter that is low or non-existent to prevent the two networks from interfering with each other, so it would not grant both requests. In this manner, a lack of accurate obstruction information (e.g., clutter and terrain information) can impede the SAS (and other network functions) from fully utilizing available frequency spectrum, thus substantially reducing network capacity.

Accordingly, implementations of the present disclosure propose optimizing spectrum assignment based on high-fidelity obstruction heights. More specifically, a computing system (e.g., physical or virtualized device(s), network function(s), etc.) can obtain information for a particular geographic area (e.g., a town, a city, a state, a geographic region, a country, a portion thereof, etc.). The information can include topographic information and clutter information. The topographic information can include terrain height values for a plurality of points within the geographic area. For example, if the terrain for a geographic area included a mountain, the topographic information would indicate a terrain height for a point located at the base of the mountain, the summit of the mountain, and any point in between.

Similarly, the clutter information can include clutter height values for at least some points within the geographic area. More specifically, the clutter information can include clutter height values at some points at which clutter exists. To follow the previous example, assume that a radio tower with a height of 80 m is located atop the summit of the mountain, and that the slopes of the mountain are bare and lack any appreciable clutter (e.g., clutter above a threshold degree of height). The clutter information may indicate a clutter height of 0 m for the slopes and 80 m for the summit. Alternatively, the clutter information may indicate 80 m for the summit, but may lack any indication of clutter height for the slopes (e.g., due to the lack of clutter).

The computing system can determine a plurality of high-fidelity obstruction height values for a plurality of sampled points from the plurality of points. The plurality of sampled points can be sampled within a portion of the geographic area located between two network entities within the geographic area. Each of the high-fidelity obstruction height values can be determined by adding the corresponding terrain height to the corresponding clutter height. For example, assume that two networks' base stations are located within a national park. The plurality of sampled points can be sampled at regular intervals along a line drawn between the two base stations. At each of the sampled points, a terrain height value for the sampled point can be added to a clutter height value for the sampled point to determine a high-fidelity obstruction height for the sampled point.

The computing system can identify critical points from the sampled points based on the high-fidelity obstruction height values, and/or the distance between each of the sampled points and the network entities (e.g., a distance between a first network entity and a sampled point, a distance between a second network entity and a sampled point, etc.). For example, the critical points may be selected from sampled points that are located within (or outside of) a distance from either of the network entity(s) and that have a total height (e.g., terrain height added to clutter height) above a threshold.

Based on the critical points, propagation information can be generated that is indicative of a predicted degree of interference for the two network entities. For example, in some implementations, the computing system can generate a propagation profile that includes a predicted degree of interference for the first network entity (e.g., the user device). If the predicted degree of interference is less than a threshold degree of interference, the computing system can make a spectrum access decision to grant the spectrum access request provided by the first network entity. In such fashion, the computing system can more accurately evaluate predicted interference for a network entity, thus enabling the computing system to grant spectrum access requests that it may otherwise reject.

Implementations of the present disclosure provide a number of technical effects and benefits. As one example technical effect and benefit, implementations described herein substantially increase network utilization efficiency. Specifically, conventional systems that mediate access to networks, such as SASs, do so based on interference predictions. Interference predictions are conventionally determined based on information describing terrain heights but not clutter heights. Without clutter height information, interference predictions can be substantially inaccurate, and as such, conventional systems must make conservative spectrum access decisions to account for these inaccuracies.

This is often accomplished by assuming a low or no clutter height scenario for a particular geographic region. Based on this “worst-case” scenario, the SAS will often deny a spectrum access request that, with access to accurate clutter information, it would otherwise grant. However, implementations described herein enable generation of propagation profiles based on high-fidelity obstruction height values, which synthesizes terrain height information with high-fidelity clutter height information (e.g., Light Detection and Ranging (LIDAR), Radar, mmWave measurements, etc.), thus enabling substantially more accurate propagation profiles and corresponding interference predictions. In turn, the capacity to more accurately predict interference enables SASs to make less conservative spectrum access decisions, thus substantially increasing network capacity.

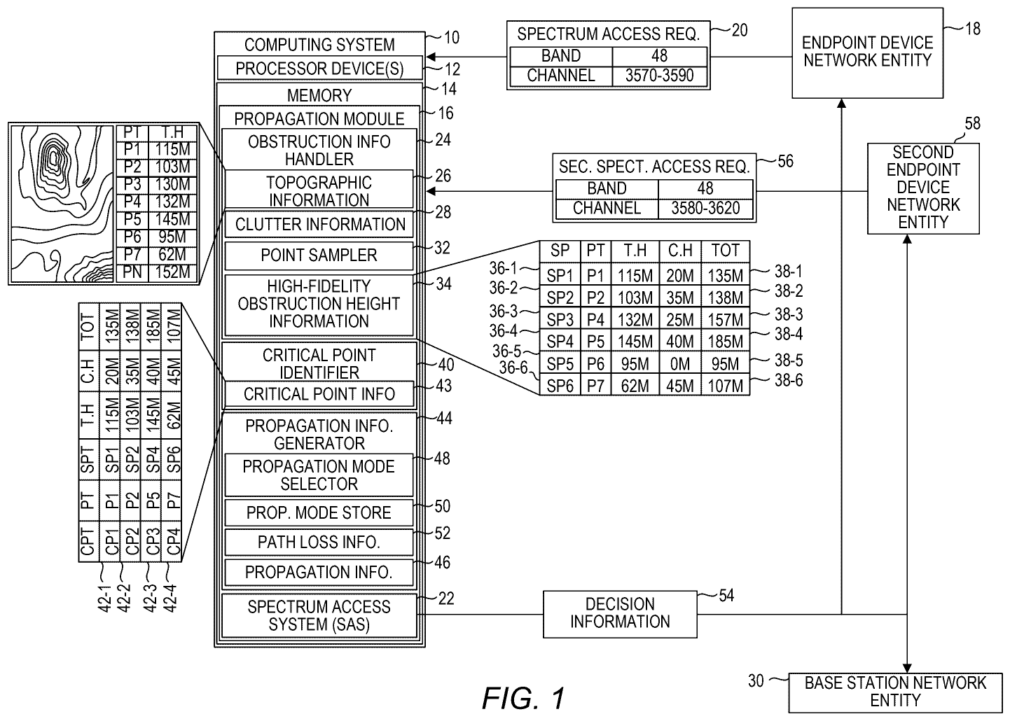

FIG. 1 is a block diagram of an environment suitable for implementing optimization of frequency spectrum assignment based on high-fidelity obstruction heights according to some implementations of the present disclosure. In some implementations, a computing system 10 includes processor device(s) 12 and memory 14. In some implementations, the computing system 10 may be a computing system that includes multiple computing devices. Alternatively, in some implementations, the computing system 10 may be one or more computing devices within a computing environment that includes multiple distributed devices and/or systems. Similarly, the processor device(s) 12 may include any computing or electronic device capable of executing software instructions to implement the functionality described herein.

The following description refers to network entities. As described herein, a network entity refers to any type or manner of entity that requests access to a network (e.g., a tiered-access network) or a region of frequency spectrum within a network (e.g., a tiered-access region of frequency spectrum, etc.). For example, a network entity may refer to network service providers (e.g., internet service providers, wireless telephony service providers, geolocation services, etc.), governmental organizations (e.g., police, military, first responders, etc.), medical personnel, private organizations, businesses, users (e.g., subscribers to network service providers), etc. The term network entity may also be interchangeably used herein to refer to device(s) used by the above-mentioned entities, such as user devices (e.g., smartphones, laptops, tablets, etc.), network devices (e.g., network nodes, endpoint devices, routers, modems, Cable Modem Termination Systems (CMTSs), etc.), network functions (e.g., SASs), etc.

Specifically, to demonstrate various implementations of the present disclosure more clearly, the computing system 10 is depicted as a computing system. However, the computing system 10 can be, or otherwise include, a variety of computing device(s) and/or network-specific device(s). Specifically, in some implementations, the computing system 10 can be, or otherwise include, a network node. The network node can perform various functions, and can include or otherwise implement various network functions. The network node can perform various functions, and can include or otherwise implement various network functions. For example, the network node may implement a SAS.

Alternatively, the network node may implement services for communicating with the SAS.

Alternatively, in some implementations, the computing system 10 can be a computing device or system that is communicatively coupled to a network node (e.g., via existing wired or wireless network infrastructure). For example, the computing system 10 can be a distributed network of computing device(s) and/or system(s) that collectively implement various wireless networking services of an Internet Service Provider (ISP).

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 14 can include a propagation module 16. The propagation module 16 can generate propagation information indicative of a predicted degree of interference for a user that requests access to a network or region of frequency spectrum within a network. Specifically, an endpoint device network entity 18 can provide a spectrum access request 20. The spectrum access request 20 can indicate a band and channel for which access is requested by the endpoint device network entity 18. An endpoint device network entity, as described herein, refers to an endpoint device utilized by a network entity, such as a user computing device, a modem, a router, a CMTS, a network node, etc.

In some implementations, the computing system 10 can determine whether to grant the spectrum access request 20 based on a predicted degree of interference caused by granting the spectrum access request 20. More specifically, the computing system 10 can, in some implementations, include a Spectrum Access System (SAS) 22. The SAS 22 can make spectrum access decisions for a wireless network implemented by a network service provider. The SAS 22 can make the spectrum access decisions based on a predicted degree of interference determined using the propagation module 16. For example, the network service provider may utilize a tiered access network such as the Citizen Broadband Radio Service (CBRS), and the SAS 22 can mediate access to the CBRS for subscribers to network services provided by the network service provider. Alternatively, in some implementations, the SAS 22 can be separate from the computing system 10, and the computing system 10 can determine a propagation profile and/or predicted degree of interference and can transmit the information to the SAS 22.

To determine the predicted degree of interference, the propagation module 16 can include an obstruction information handler 24. The obstruction information handler 24 can obtain, store, modify, or otherwise handle multiple types and sources of obstruction information. In some implementations, the obstruction information handler 24 can process information to extract or otherwise obtain the obstruction information. For example, the obstruction information handler 24 may process high-fidelity LIDAR information to determine clutter height information.

In particular, the obstruction information handler 24 can include topographic information 26 and clutter information 28 for a particular geographic area. As described herein, a “geographic area” refers to any type or manner of physical area, and may be demarcated to any degree of specificity, such as a street, city block, town, city, county, state, country, zip code, telecommunications sector, etc. The topographic information 26 can describe a terrain height at multiple points within the geographic area. In some implementations, the topographic information 26 can describe the terrain height at every point within the geographic area.

As depicted, the topographic information 26 includes height information for N points within the geographic area. However, it should be noted that the topographic information 26 is depicted in this manner only to more easily illustrate various implementations of the present disclosure. Rather, in some implementations, the topographic information may assign height values to certain regions within the geographic area. For example, the topographic information 26 may be, include, or be coupled to a model (e.g., the Longley-Rice model/Irregular Terrain model (ITM), the Terrain Integrated Rough Earth Model (TIREM), etc.) and such height values may be retrieved by sampling at points within the geographic area.

The clutter information 28 can include, or otherwise indicate, clutter height values for clutter located atop the terrain within the particular geographic area. As described herein, “clutter” refers to any object (e.g., vegetation, billboard, infrastructure, etc.), building, man-made entity, etc. located atop the terrain of a geographic area. In some instances, the differences between terrain height and the combination of terrain and existing clutter height can be substantial. For example, while the terrain of New York City in some locations is only 2-3 meters above sea level, clutter located atop the terrain of New York City can be over 400 meters in height (e.g., the One World Trade Center, the Empire State Building, etc.).

In some implementations, the clutter information 28 can be, or can be derived from, high-resolution imagery information. Specifically, in some implementations, the clutter information 28 can be, or can be derived from, LIDAR information. For example, LIDAR imagery (e.g., imagery from autonomous vehicle data sets, etc.) can be obtained for a particular point, and ray tracing can be utilized to determine clutter heights from that particular point. The clutter information 28 may include the LIDAR imagery, the clutter heights derived from the LIDAR imagery, or both. For another example, the clutter information 28 may include high-resolution images depicting clutter from the perspective of a particular point (e.g., street-view imagery, etc.), satellite imagery, infrared imagery, point clouds, etc.

The topographic information 26 and the clutter information 28 can be obtained in response to receipt of the spectrum access request 20. More specifically, upon receipt of the spectrum access request 20, the propagation module 16 can determine a location of the endpoint device network entity 18 and a base station network entity 30 that would serve, or is serving, a different endpoint device network entity and may in the process interfere with the endpoint device network entity 18. The location of the endpoint device network entity 18 may not be known exactly and can, for example, be hypothesized to be in the coverage area of its own serving base station entity. The propagation module 16 can then determine the geographic area in which both the endpoint device network entity 18 and the base station network entity 30 are located. For example, the spectrum access request 20 may indicate the location of the endpoint device network entity 18 and the base station network entity 30, or the locations could be indicated in a registration request received earlier, or identified in a known database. Alternatively, the propagation module 16 may identify the particular geographic area in some other manner (e.g., pinging the endpoint device network entity 18 for location information, etc.).

The propagation module 16 can include a point sampler 32. The point sampler 32 can sample a plurality of sampled points 34-1-34-6 (generally, sampled points 34) from the plurality of points within the particular geographic area with terrain height values included in the topographic information 26. More specifically, the point sampler 32 can sample the plurality of sampled points 34 from points located between the endpoint device network entity 18 and the base station network entity 30 for which height information is included in the topographic information 26. For example, if a line was drawn between the location of the endpoint device network entity 18 and the base station network entity 30 within the geographic area, the plurality of sampled points 34 may be located at regular intervals along the line.

The propagation module 16 can generate high-fidelity obstruction height information 34. The high-fidelity obstruction height information 34 can include a plurality of high-fidelity obstruction height values 38-1-38-6 (generally, high-fidelity obstruction height values 38) for the sampled points 34. The high-fidelity obstruction height values can synthesize the topographic height values with the clutter height values described by the topographic information 26 and the clutter information 28, respectively. To follow the depicted example, the sampled point 36-1 has a terrain height of 115M, a clutter height of 20M, and thus the value of high-fidelity obstruction height value 38-1 is 115. For another example, the sampled point 36-2 has a terrain height of 103M, a clutter height of 35M, and thus the value of high-fidelity obstruction height value 38-2 is 103.

It should be noted that the plurality of sampled points 34 do not include all of the points included in the geographic area, or even the points described by the topographic information 26. For example, the point P7 depicted in FIG. 1 is not included as one of the plurality of sampled points 34. Similarly, it should be noted that the high-fidelity obstruction height values 38 are not necessarily calculated for each point, or each sampled point. For example, if a sampled point lacks appreciable clutter (e.g., clutter above a threshold height), or if clutter information does not exist for a sampled point, the computing system 10 may refrain from determining a high-fidelity obstruction height value for the sampled point, or may refrain from sampling the point altogether.

The propagation module 16 can include a critical point identifier 40. The critical point identifier 40 can identify critical points 42-1-42-4 (generally, critical points 42) from the sampled points 34. To follow the depicted example, the critical points 42 selected by the critical point identifier 40 include sampled points 34-1, 34-2, 34-4, and 34-6. Critical points, as defined herein, are points that can be utilized to determine a predicted degree of interference for the endpoint device network entity 18 (e.g., when the base station network entity 30, is communicating with its own end point).

Critical points often correspond to locations in which a combination of clutter and terrain height is likely to physically obstruct a signal transmitted from an endpoint device to a base station (and vice-versa) that would interfere with other signaling. The critical point identifier 40 can store critical point information 43 that is descriptive of the critical points 42, the high-fidelity obstruction height values 38 for the critical points 42, etc.

The critical points 42 can be identified based on multiple types of information. In particular, the sampled points 34 can be identified as critical points 42 based on the high-fidelity obstruction height values 38 for the sampled points 36, the distance between the sampled points 34 and the endpoint device network entity 18, the distance between the sampled points 34 and the base station network entity 30, the distances between sampled points (e.g., the distance between a sampled point and another sampled point that is already selected as a critical point), etc. As such, the sampled points 34 that are selected as the critical points 42 are not necessarily the sampled points 34 with the highest high-fidelity obstruction height values 38.

For example, the sampled point 36-1 may be selected as the critical point 42-1 for having the high-fidelity height obstruction value 38-1 of 135M, while the sampled point 36-5 may be identified as not being one of the critical points 42 for having the high-fidelity height value 34-5 of 95M while also being most proximate to a sampled point already selected as a critical point (e.g., sampled point 36-6 selected as critical point 42-4).

The propagation module 16 can include a propagation information generator 44. The propagation information generator 44 can generate propagation information 46. The propagation information 46 can include, or otherwise indicate, a predicted degree of interference for the endpoint device network entity 18, or may include propagation profile information from which a predicted degree of interference can be derived.

To do so, the propagation information generator 44 can include a propagation mode selector 48. The propagation mode selector 48 can select one or more of a number of candidate propagation modes stored in propagation mode store 50. As described herein, a “propagation mode” refers to a mode in which a predicted degree of interference can be determined, or a mode used to generate information from which a predicted degree of interference can be derived (e.g., a path loss estimation, etc.). Examples of propagation modes include Free Space Loss (FSL), Line of Sight (LOS), Diffraction, Tropo-scatter, etc.).

The propagation mode selector 48 can select one or more propagation modes from the propagation mode store 50. For example, the propagation mode selector 48 may select one propagation mode to determine a path loss prediction, or may select multiple propagation modes to determine multiple path loss predictions. The propagation mode selector 48 can select the propagation mode(s) based on the critical points 42. It should be noted that, in some instances, the selected propagation mode can have a substantial effect on the path loss prediction and/or the interference prediction. Further, the propagation mode(s) are selected based on the critical points, which are selected based on the high-fidelity obstruction height values 38, which in turn are synthesized from clutter height values from the clutter information 28. As such, the synthesis of the topographic information 26 and the clutter information 28 can have substantial downstream effects on the predicted degree of interference.

In some implementations, the selected propagation mode can be utilized to generate the propagation information 46. Alternatively, in some implementations, the selected propagation mode can be used to generate path loss information 52. The path loss information 52 can include a path loss prediction for communications from the endpoint device network entity 18. The path loss information 52 can be utilized by the propagation information generator 44 to generate the propagation information 46. For example, path loss values indicated by the path loss information 52 may be used to determine projected received interference levels for the endpoint device network entity 18 and/or the base station network entity 30.

In some implementations, the computing system 10 can include the SAS 22, and the SAS 22 can generate decision information 54. The decision information 54 can indicate whether the spectrum access request 20 has been granted by the SAS 22. To follow the depicted example, assume that the SAS 22 receives the spectrum access request 20 and a second spectrum access request 56 from a second endpoint device network entity 58. The second spectrum access request 56 can request access to a frequency band that at least partially overlaps with the frequency band indicated by the spectrum access request 20. To determine whether such overlap is acceptable, the SAS can request the propagation information 46 for the endpoint device network entity 18 from the propagation module 16. If the propagation information 46 indicates a degree of predicted interference less than a threshold degree of interference, the decision information 54 can indicate that the spectrum access request 20 has been granted. Alternatively, if the propagation information 46 indicates a degree of predicted interference greater than or equal to a threshold degree of interference, the decision information 54 can indicate that the spectrum access request 20, and/or the second spectrum access request 56, has been denied.

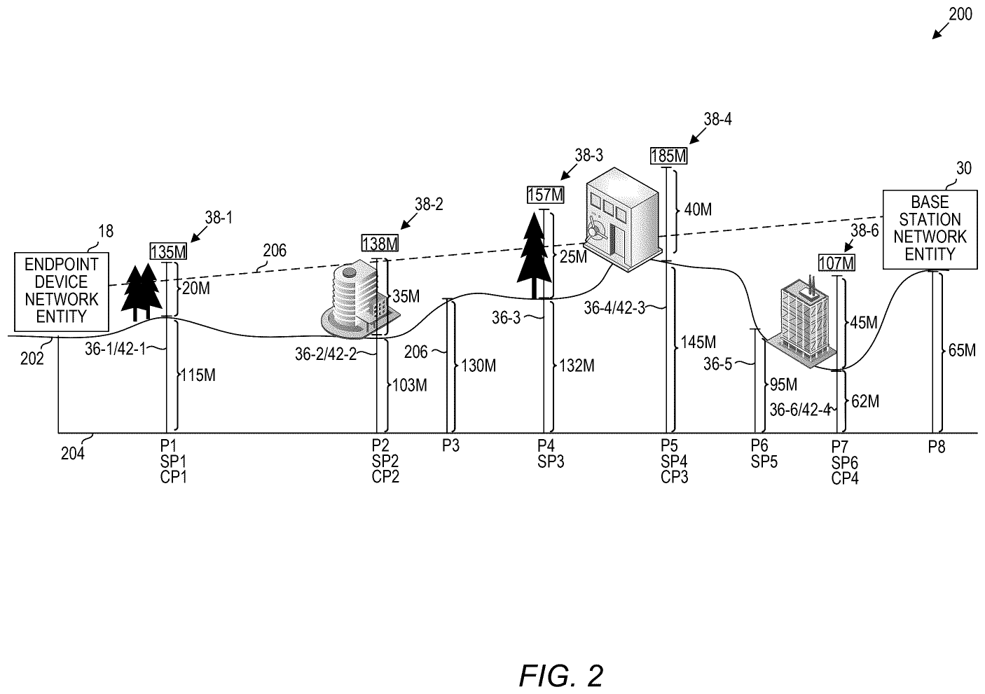

FIG. 2 depicts an example geographic area 200 including network entities for which high-fidelity obstruction height values are synthesized for optimizing frequency spectrum assignment according to some implementations of the present disclosure. FIG. 2 will be discussed in conjunction with FIG. 1. Specifically, the geographic area 200 is depicted with a two-dimensional view of a terrain 202 and a line to indicate a reference sea level height 204.

The endpoint device network entity 18 and the base station network entity 30 are located on the surface of the terrain 202, and a Line-of-Sight (LOS) 206 is illustrated between the endpoint device network entity 18 and the base station network entity 30. As illustrated, the sampled points 36 are sampled along the LOS 206. The terrain height value, the clutter height value, and the resulting high-fidelity obstruction height value 38. For example, the sampled point 26-1 has a terrain height of 115M, a clutter height of 20M, and a resulting high-fidelity obstruction height value 38-1 of 135M.

As illustrated, in some instances the critical point identifier 40 can refrain from identifying one of the sampled points 36 as one of the critical points 42 based on a lack of corresponding clutter located at the sampled point 36. To follow the depicted example, there is no clutter located atop the surface of the terrain 202 at the sampled point 36-3. As such, it is relatively unlikely that the sampled point 36-3 will be particularly relevant for predicting interference for the endpoint device network entity 18. In other words, the sampled point 36-3 is unlikely to be a “critical” point for predicting interference, because there is no clutter that could block one signal from interfering from the other signal. Conversely, clutter in the form of a 40M high building is located atop the surface of the terrain 202 at the sampled point 36-4, and as such, the critical point identifier 40 selects the sampled point 36-4 as the critical point 42-3.

Additionally, or alternatively, in some implementations, the critical point identifier 40 can select, or refrain from selecting, a sampled point as a critical point based on distance(s) between the sampled point and other sampled points, the sampled point and a network entity, etc. For example, the sampled point 36-3 has a relatively high terrain height of 132M. Further, appreciable clutter with a height of 25M is located atop the surface of the terrain 202 at the sampled point 36-3, and the high-fidelity obstruction height value 38 of the sampled point 36-3 is 157M. However, the sampled point 36-3 is most proximate to another sampled point 36-4 with a clutter height of 40M, and the high-fidelity obstruction height value 38 of the sampled point 36-4 is 185M. As such, the critical point identifier 40 may select the sampled point 36-4 as the critical point 42-3, and refrain from selecting the sampled point 36-3 as a critical point.

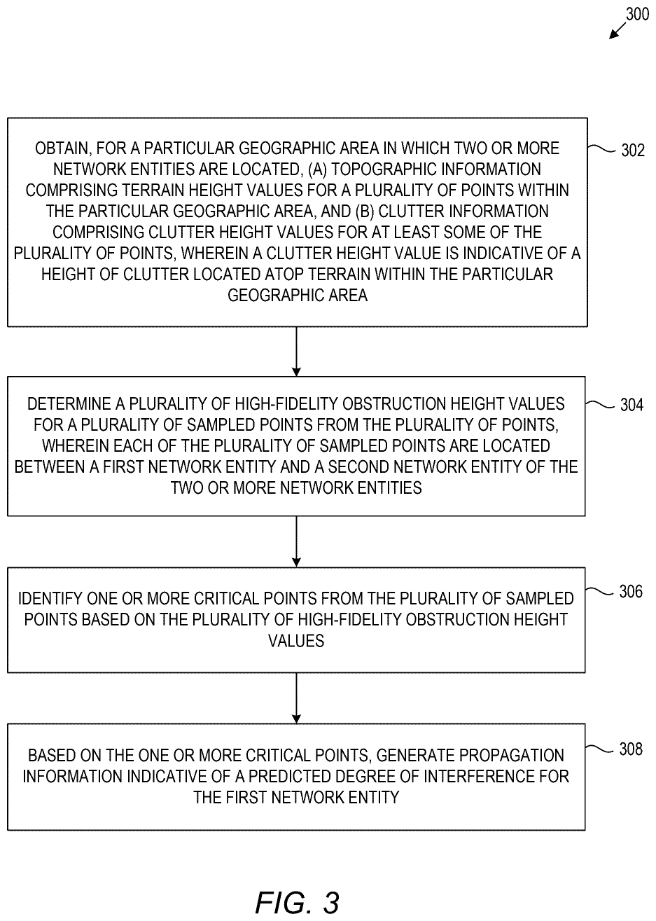

FIG. 3 depicts a flow chart diagram of an example method 300 to perform optimization of frequency spectrum assignment based on high-fidelity obstruction heights according to some implementations of the present disclosure. Although FIG. 3 depicts operations performed in a particular order for purposes of illustration and discussion, the methods of the present disclosure are not limited to the particularly illustrated order or arrangement. The various operations of the method 300 can be omitted, rearranged, combined, and/or adapted in various ways without deviating from the scope of the present disclosure.

At operation 302, a computing system can obtain, for a particular geographic area in which two or more network entities are located, (a) topographic information comprising terrain height values for a plurality of points within the particular geographic area, and (b) clutter information comprising clutter height values for at least some of the plurality of points. A clutter height value can be indicative of a height of clutter located atop terrain within the particular geographic area. In some implementations, the clutter information includes high-fidelity LIDAR information.

In some implementations, the first network entity can be, include, or be associated with an endpoint device, and the second network entity can be, include, or be associated with a base station.

At operation 304, the computing system can determine a plurality of high-fidelity obstruction height values for a plurality of sampled points from the plurality of points. Each of the plurality of sampled points can be located between a first network entity and a second network entity of the two or more network entities. In some implementations, the computing system can sample the plurality of sampled points from the plurality of points. Each of the plurality of sampled points can be located along a line from the first network entity to the second network entity.

At operation 306, the computing system can identify one or more critical points from the plurality of sampled points based on the plurality of high-fidelity obstruction height values. In some implementations, the critical point(s) can be identified based on the high-fidelity obstruction height value of the plurality of high-fidelity obstruction height values that corresponds to the critical point, a distance between the critical point and the first network entity, and/or a distance between the critical point and the second network entity.

At operation 308, the computing system can, based on the one or more critical points, generate propagation information indicative of a predicted degree of interference for the first network entity. In some implementations, the computing system can, based on the one or more critical points, select one or more propagation modes from a plurality of propagation modes. The computing system can use the one or more propagation modes to generate one or more corresponding path loss values. The computing system can determine the predicted degree of interference for the first network entity based on the one or more path loss values. In some implementations, the propagation modes include Free Space Loss (FSL), Line-Of-Sight (LOS), diffraction, and/or tropo-scatter.

In some implementations, the computing system can make a spectrum access decision for the first network entity based at least in part on the propagation information. In some implementations, prior to making the spectrum access decision, the computing system can obtain a first spectrum access request from the first network entity. The first spectrum access request can include a request to access a first frequency band. The computing system can obtain a second spectrum access request from a third network entity of the two or more network entities. The third network entity can be, include, or be associated with a second endpoint device. The second spectrum access request can include a request to access a second frequency band that at least partially overlaps the first frequency band.

In some implementations, to make the spectrum access decision, the computing system can determine that the predicted degree of interference is less than a threshold degree of interference. The computing system can cause the first spectrum access request and/or the second spectrum access request to be granted. For example, if the computing system is or otherwise implements a SAS, the computing system can grant the first spectrum access request. Alternatively, the computing system can instruct a SAS to grant the request or can provide information to the SAS sufficient to enable the SAS to grant the request.

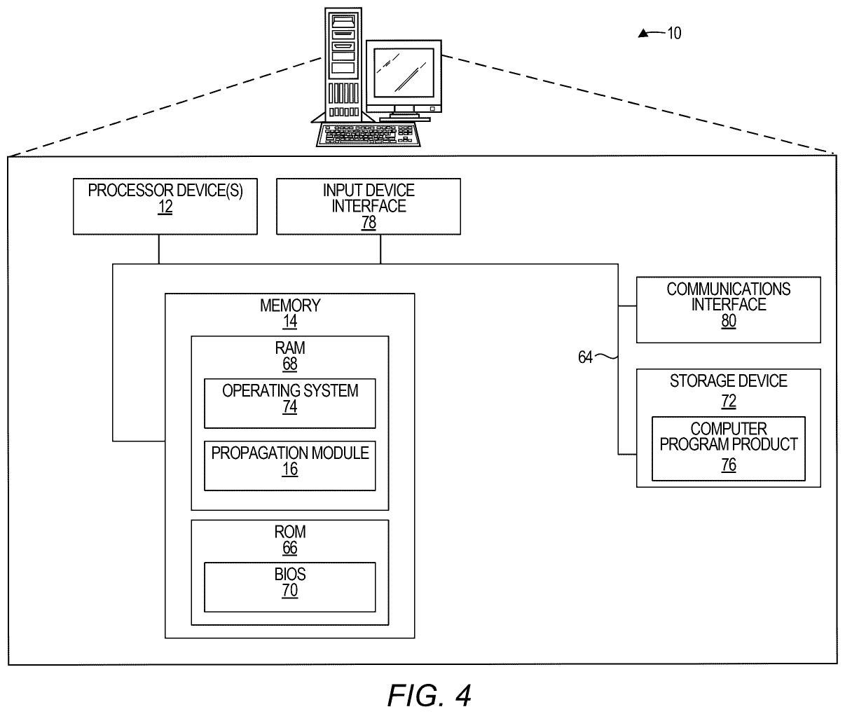

FIG. 4 is a block diagram of the computing system 10 suitable for implementing examples according to one example. The computing system 10 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 10 includes the one or more processor devices 12, the memory 14, and a system bus 64. The system bus 64 provides an interface for system components including, but not limited to, the memory 14 and the processor device(s) 12. The processor device(s) 12 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The memory 14 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the computing system 10. The volatile memory 68 may also include a high-speed RAM, such as static RAM, for caching data.

The computing system 10 may further include or be coupled to a non-transitory computer-readable storage medium such as a storage device 72, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 72 and other drives associated with computer-readable media and computer-usable media may provide non-volatile storage of data, data structures, computer-executable instructions, and the like.

A number of modules can be stored in the storage device 72 and in the volatile memory 68, including an operating system 74 and one or more program modules, such as the propagation module 16, which may implement the functionality described herein in whole or in part. All or a portion of the examples may be implemented as a computer program product 76 stored on a transitory or non-transitory computer-usable or computer-readable storage medium, such as the storage device 72, which includes complex programming instructions, such as complex computer-readable program code, to cause the processor device(s) 12 to carry out the steps described herein. Thus, the computer-readable program code can comprise software instructions for implementing the functionality of the examples described herein when executed on the processor device(s) 12. The processor device(s) 12, in conjunction with the propagation module 16 in the volatile memory 68, may serve as a controller, or control system, for the computing system 10 that is to implement the functionality described herein.

Because the propagation module 16, and/or the SAS 22, is a component of the computing system 10, functionality implemented by the propagation module 16 and/or SAS 22 may be attributed to the computing system 10 generally. Moreover, in examples where the propagation module 16 and/or SAS 22 comprises software instructions that program the processor device(s) 12 to carry out functionality discussed herein, functionality implemented by the propagation module 16 and/or SAS 22 may be attributed herein to the processor device(s) 12.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 12 through an input device interface 78 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The computing system 10 may also include the communications interface 80 suitable for communicating with the network as appropriate or desired. The computing system 10 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a computing system comprising one or more processor devices, for a particular geographic area in which two or more network entities are located:
(a) topographic information comprising terrain height values for a plurality of points within the particular geographic area; and
(b) clutter information comprising clutter height values for at least some of the plurality of points, wherein a clutter height value is indicative of a height of clutter located atop terrain within the particular geographic area;
determining, by the computing system, a plurality of high-fidelity obstruction height values for a plurality of sampled points from the plurality of points, wherein each of the plurality of sampled points are located between a first network entity and a second network entity of the two or more network entities;
identifying, by the computing system, one or more critical points from the plurality of sampled points based on the plurality of high-fidelity obstruction height values; and
based on the one or more critical points, generating, by the computing system, propagation information indicative of a predicted degree of interference for the first network entity.

2. The method of claim 1, wherein the method further comprises:
making, by the computing system, a spectrum access decision for the first network entity based at least in part on the propagation information.

3. The method of claim 2, wherein the first network entity comprises an endpoint device, and wherein the second network entity comprises a base station.

4. The method of claim 3, wherein, prior to making the spectrum access decision for the first network entity, the method comprises:
obtaining, by the computing system:
a first spectrum access request from the first network entity, wherein the first spectrum access request comprises a request to access a first frequency band; and
a second spectrum access request from a third network entity of the two or more network entities comprising a second endpoint device, wherein the second spectrum access request comprises a request to access a second frequency band that at least partially overlaps the first frequency band.

5. The method of claim 4, wherein making the spectrum access decision for the first network entity comprises:
determining, by the computing system, that the predicted degree of interference is less than a threshold degree of interference; and
causing, by the computing system, the first spectrum access request to be granted.

6. The method of claim 5, wherein the method further comprises:
causing, by the computing system, the second spectrum access request to be granted.

7. The method of claim 3, wherein the computing system comprises a Spectrum Access System (SAS).

8. The method of claim 1, wherein determining the plurality of high-fidelity obstruction height values for the plurality of sampled points from the plurality of points comprises:
sampling, by the computing system, the plurality of sampled points from the plurality of points, wherein each of the plurality of sampled points is located along a line from the first network entity to the second network entity.

9. The method of claim 1, wherein the clutter information comprises high-fidelity Light Detection and Ranging (LIDAR) information.

10. The method of claim 1, wherein identifying the one or more critical points from the plurality of sampled points comprises:
identifying, by the computing system, the one or more critical points from the plurality of sampled points, wherein each of the one or more critical points is identified based on at least one of:
the high-fidelity obstruction height value of the plurality of high-fidelity obstruction height values that corresponds to the critical point;
a distance between the critical point and the first network entity; or
a distance between the critical point and the second network entity.

11. The method of claim 1, wherein generating the propagation information indicative of the predicted degree of interference comprises:
based on the one or more critical points, selecting, by the computing system, one or more propagation modes from a plurality of propagation modes;
using, by the computing system, the one or more propagation modes to generate one or more corresponding path loss values; and
determining, by the computing system, the predicted degree of interference for the first network entity based on the one or more path loss values.

12. The method of claim 11, wherein the plurality of propagation modes comprises at least one of:
Free Space Loss (FSL);
Line-Of-Sight (LOS);
diffraction; or
tropo-scatter.

13. A computing system comprising:
one or more processor devices configured to:
obtain, for a particular geographic area in which two or more network entities are located:
(a) topographic information comprising terrain height values for a plurality of points within the particular geographic area; and
(b) clutter information comprising clutter height values for at least some of the plurality of points, wherein a clutter height value is indicative of a height of clutter located atop terrain within the particular geographic area;
determine a plurality of high-fidelity obstruction height values for a plurality of sampled points from the plurality of points, wherein each of the plurality of sampled points are located between a first network entity and a second network entity of the two or more network entities;
identify one or more critical points from the plurality of sampled points based on the plurality of high-fidelity obstruction height values; and
based on the one or more critical points, generate propagation information indicative of a predicted degree of interference for the first network entity.

14. The computing system of claim 13, wherein the one or more processor devices are further configured to:
make a spectrum access decision for the first network entity based at least in part on the propagation information.

15. The computing system of claim 14, wherein the first network entity comprises an endpoint device, and wherein the second network entity comprises a base station.

16. The computing system of claim 15, wherein, prior to making the spectrum access decision for the first network entity, the one or more processor devices are configured to:
obtain:
a first spectrum access request from the first network entity, wherein the first spectrum access request comprises a request to access a first frequency band; and
a second spectrum access request from a third network entity of the two or more network entities comprising a second endpoint device, wherein the second spectrum access request comprises a request to access a second frequency band that at least partially overlaps the first frequency band.

17. The computing system of claim 16, wherein making the spectrum access decision for the first network entity comprises:
determining that the predicted degree of interference is less than a threshold degree of interference; and
causing the first spectrum access request to be granted.

18. The computing system of claim 17, wherein the one or more processor devices are further configured to:
cause the second spectrum access request to be granted.

19. The computing system of claim 15, wherein the computing system implements or is communicatively coupled to a SAS.

20. A non-transitory computer-readable storage medium that includes executable instructions configured to cause one or more processor devices to:
obtain, for a particular geographic area in which two or more network entities are located:
(a) topographic information comprising terrain height values for a plurality of points within the particular geographic area; and
(b) clutter information comprising clutter height values for at least some of the plurality of points, wherein a clutter height value is indicative of a height of clutter located atop terrain within the particular geographic area;
determine a plurality of high-fidelity obstruction height values for a plurality of sampled points from the plurality of points, wherein each of the plurality of sampled points are located between a first network entity and a second network entity of the two or more network entities;
identify one or more critical points from the plurality of sampled points based on the plurality of high-fidelity obstruction height values; and
based on the one or more critical points, generate propagation information indicative of a predicted degree of interference for the first network entity.
